(19) United States
(12) Patent Application Publication
(10) Pub. No.: US 2007/0034322 A1
(43) Pub. Date: Feb. 15, 2007

(54) System and process for making a coated article

(75) Inventors: Arnaud Glacet, Clearwater, FL (US); Peiqi Jiang, Tarpon Springs, FL (US)

Correspondence Address: FULBRIGHT & JAWORSKI L.L.P., 600 CONGRESS AVE., SUITE 2400, AUSTIN, TX, 78701, US

(73) Assignee: Essilor International Compagnie Generale d'Optique, Charenton cedex (FR)

(21) Appl. No.: 11/345,613

(22) Filed: Feb. 1, 2006

Related U.S. Application Data
(63) Continuation-in-part of application No. 11/204,267, filed on Aug. 15, 2005.

(51) Int. Cl. B44C 1/165; B44C 1/17; B32B 37/12; B05C 11/00

(52) U.S. Cl. 156/230; 118/76; 156/580; 156/581; 156/239; 156/241

(57) ABSTRACT

Systems for transferring at least one coating from a carrier to a surface of an optical article which comprise: an optical article to be coated; a flexible carrier bearing at least one coating to be transferred; an inflatable membrane; and a deformable part that is able to match the geometry of a surface of the optical article when a pressure is exerted on the optical article through inflation of the inflatable membrane. Also describes are methods and processes of using such systems; carriers for use in such systems, methods, and processes; and optical articles made using such systems, methods, and processes.

### CROSS-REFERENCE TO RELATED APPLICATIONS

This application is a continuation-in-part of co-pending U.S. patent application Ser. No. 11/204,267 filed Aug. 15, 2005. The entire text of the above-referenced disclosure is specifically incorporated by reference herein without disclaimer.

### BACKGROUND OF THE INVENTION

1. Field of the Invention

The present invention relates to a system and a process for applying at least one coating on a front convex surface of an article, in particular an optical article such as an ophthalmic lens.

2. Description of the Related Art

It is a common practice in the art to coat at least one main surface of an optical article, such as an ophthalmic lens or lens blank, with one or several coatings for imparting to the finished or semi-finished optical article additional or improved optical and/or mechanical properties.

Thus, it is usual practice to coat at least one main surface of an optical article, typically made of an organic glass material, with successively, starting from the surface of the optical article, an impact-resistant coating (impact resistant primer), an abrasion and/or scratch-resistant coating (hard coat), an anti-reflecting coating and, optionally, a hydrophobic and/or oleophobic top coat (top coat). Other coatings such as a polarizing coating, a photochromic coating or a coloured coating may also be applied onto one or both surfaces of the optical article.

Numerous processes and methods have been proposed for coating a surface of an optical article and are disclosed.

U.S. Pat. No. 6,562,466 describes one process or method for transferring a coating from at least a mold part onto at least a geometrically defined surface of a lens blank which comprises:
providing a lens blank having at least one geometrically defined surface;
providing a carrier or mold part having an internal surface bearing a coating and an external surface;
depositing on said geometrically defined surface of said lens blank or on said coating a pre-measured amount of a curable adhesive composition;
moving relatively to each other the lens blank and the support to either bring the coating into contact with the curable adhesive composition or bring the curable adhesive composition into contact with the geometrically defined surface of the lens blank;
applying a sufficient pressure onto the external surface of the carrier;
curing the layer of adhesive composition; and
recovering the lens blank with the coating adhered onto the geometrically defined surface of the lens blank.

The pressure exerted against the external surface of the carrier can result from inflation of an inflatable membrane.

Although, these prior art transfer processes and methods envisaged coating both rear and front surfaces of the lens blank, they principally consider coating the rear concave surface of a lens blank (back side transfer or BST). Difficulties are still encountered using such processes and methods for transferring a coating on a front convex surface of an optical article.

In particular, when an inflatable membrane is used for transferring a coating from a carrier onto a front convex surface of an optical article “no transfer spots and/or areas” may be present on the final article. Deformations of the optical surface of the article may also occur, especially when a heating cycle is used during the transfer process.

### SUMMARY OF THE INVENTION

Therefore, one object of the invention is to provide a system and a process for transferring a coating from a flexible carrier onto a front convex surface of an optical article which

1) avoids optical deformation, especially at high temperatures such as typically 70° C. to 110° C.,

2) avoids the presence of “no transfer spots and/or areas” in the resulting coated optical article.

The process of the invention is particularly preferred for transferring coatings on the surface of optical articles such as ophthalmic lenses having a negative power, which are thinner at the center than at the periphery of the lens.

The above object is achieved according to the invention by means of a system for transferring at least one coating from a carrier onto a front convex surface of an optical article which comprises:
an optical article to be coated having a front convex surface and a back concave surface;
a flexible carrier having a concave surface and a convex surface, said concave surface of the carrier bearing at least one coating to be transferred and facing the front convex surface of the optical article;
a means capable to allow adhesion of the coating born by the flexible carrier onto the front convex surface of the optical article;
an inflatable membrane positioned in front of the convex surface of the carrier; and
a deformable means positioned in front of the back concave surface of the optical article and able to match the geometry of said back concave surface of the optical article when a pressure is exerted on the optical article through inflation of the inflatable membrane.

The invention also concerns a process for making a coated optical article which comprises:
providing an optical article having a front convex surface and a back concave surface;
providing a flexible carrier having a concave surface and a convex surface, said concave surface of the flexible carrier bearing at least one coating;
providing a means capable to allow adhesion of the coating born by the flexible carrier onto the front convex surface of the optical article;
providing a pressing apparatus comprising a device having an inflatable membrane and a deformable means defining there between a receiving space;
positioning the flexible carrier, within the receiving space, in front of, preferably on, the inflatable membrane with its coated concave surface facing the deformable means;
placing the optical article, within the receiving space, in front of, preferably on, the concave surface of the flexible carrier, with its front convex surface facing the flexible carrier and its concave surface facing the deformable means;
inflating the inflatable membrane so that the deformable means matches the back concave surface of the optical article;
optionally curing the adhesion allowing means;
deflating the inflatable membrane; and
recovering the optical article with its front convex surface coated with said at least one coating transferred from the flexible carrier.

More specifically, the means capable to allow adhesion is either an exposed adhesive layer or an exposed dry latex layer whose adhesion is activated by a water base activating liquid such as water, a mixture of water and at least one organic solvent or a latex or a mixture of an aqueous solvent and a latex, formed on the coating or the front convex surface of the optical article associated with an amount of a water base activating liquid deposited on the latex layer, the coating or the front convex surface of the optical article, or it can also be an amount of a liquid curable glue deposited on either the coating born by the flexible carrier or the front convex surface of the optical article.

Of course, when the means capable to allow adhesion is a dry activable latex layer, the presence of an amount of water base activating liquid is necessary.

As indicated above, the water base activating liquid can be water, preferably deionised water, a mixture of water and at least one organic solvent, such as an alkanol, preferably a C1-C6 alkanol.

The water base activating liquid may also be a latex or a mixture of an aqueous solvent and a latex. The latexes can be the same as those used for forming the dry latex layer and are preferably polyurethane latexes.

Preferably, the latex or mixtures of an aqueous solvent and latex have a dry extract of up to 20% by weight, better up to 15% by weight.

By “activating liquid” there is meant a liquid which, when contacting the dry latex layer under the processing conditions, in particular under heating, imparts to the dry latex layer adhesive properties.

When a dry latex and a water base activating liquid are used as the adhesion means, the thin pellicule of water base activating liquid and the dry latex layer are heated while under pressure.

Preferably, heating step is performed at a temperature higher than the “tacky” temperature of the dry latex layer. The “tacky” temperature is the temperature at which the dry latex layer becomes sticky.

Typically, heating step is performed at a temperature ranging from 40° C. to 130° C., preferably 50° C. to 120° C.

By exposed adhesive layer there is meant a layer which effectively will provide adhesion of the coating onto the optical article and which is the outermost layer either of the coating or formed on the coating or the surface to be coated of the optical article.

In one embodiment the deformable means is a rubber cushion, preferably made of a silicone foam rubber.

In a further preferred embodiment the deformable means is an additional inflatable membrane device, the inflatable membrane of which is itself inflated under pressure. The first inflatable membrane, i.e. the inflatable membrane on which the flexible carrier is positioned and the second inflatable membrane, i.e. the additional inflatable membrane are preferably inflated at the same speed. More preferably, the second additional inflatable membrane is first inflated until it touches the centre of the back concave surface of the optical article, then the pressure is equalized in both first and second inflatable membranes and both membranes are simultaneously inflated at the same speed.

Preferably, the first and second membranes are made of the same material.

In still another embodiment, the above process wherein the deformable means is an additional inflatable membrane, further comprises the steps of:
providing an additional flexible carrier having a concave surface and a convex surface, the convex surface thereof bearing at least one coating to be transferred;
providing a means capable to allow adhesion of the coating born by the flexible carrier onto the back concave surface of the optical article;
placing the additional carrier, within the receiving space, in front of, preferably on the concave surface of the optical article, with its coated convex surface facing the back concave surface of the optical article, and conversely its concave surface facing the second inflatable membrane;

whereby both surfaces of the optical article are coated simultaneously.

The same features as disclosed above apply for coating the back concave surface of the optical article; In that case, obviously, the considered surfaces of the carrier and of the optical article are reversed, i.e the coated carrier surface is the convex surface and the optical article surface to be coated is the concave surface.

Preferably, only the front convex surface of the optical article is coated using the system and method of the invention, consequently no coating is transferred according to the process of the invention on the back surface of the optical article.

Typically, the front convex surface of the optical article can be spheric, aspheric, or a progressive curve.

Preferably, the front convex spherical surface base (B_{L}) of the optical article and concave surface base (B_{C}) of the flexible carrier satisfy the relationship:
B_{L}−B_{C}>0.25
More preferably, B_{L}−B_{C}>0.5
and even better 0,5<B_{L}−B_{C}<4
For a progressive ophthalmic lens having a progressive surface in the front side, one preferably fulfils the following relationship:
0.5<B′_{L}−B_{C}<8 wherein B′_{L} is defined as being B_{L}+ addition wherein B_{L} is the base of the progressive surface of the lens and addition is the additional power given by the progressive lens for near vision.

More preferably, 0.5<B′_{L}−B_{C}<6.

Preferably, the optical article is a finished or semi-finished lens, in particular an ophthalmic lens.

### BRIEF DESCRIPTION OF THE DRAWINGS

The foregoing and other objects, features and advantages of the present invention will become readily apparent to those skilled in the art from a reading of the detailed description when considered in conjunction with the accompanying drawings wherein:

FIG. 1 is a perspective view of a dual inflatable membrane pressing apparatus which can be used in the system and the method of the invention;

FIG. 2 is a perspective view of the dual inflatable membrane pressing apparatus of FIG. 1 with the upper inflatable membrane device removed;

FIG. 3 is a schematic cross-sectional view of the dual inflatable membrane pressing apparatus of FIG. 1;

FIGS. 4A to 4F, are schematic views of steps of the coating transfer process of the invention using the dual inflatable membrane apparatus of FIG. 1;

FIG. 5, a schematic cross-sectional view of a system according to the invention in which the pressing apparatus comprises a single inflatable membrane device and a rubber cushion as the deformable means.

FIG. 6, schematic views of the apparatus for measuring the “tacky” temperature with the probe in up and down positions; and

FIG. 7, a graph of registration for measuring the “tacky” temperature.

### DETAILED DESCRIPTION OF THE INVENTION AND PREFERRED EMBODIMENTS

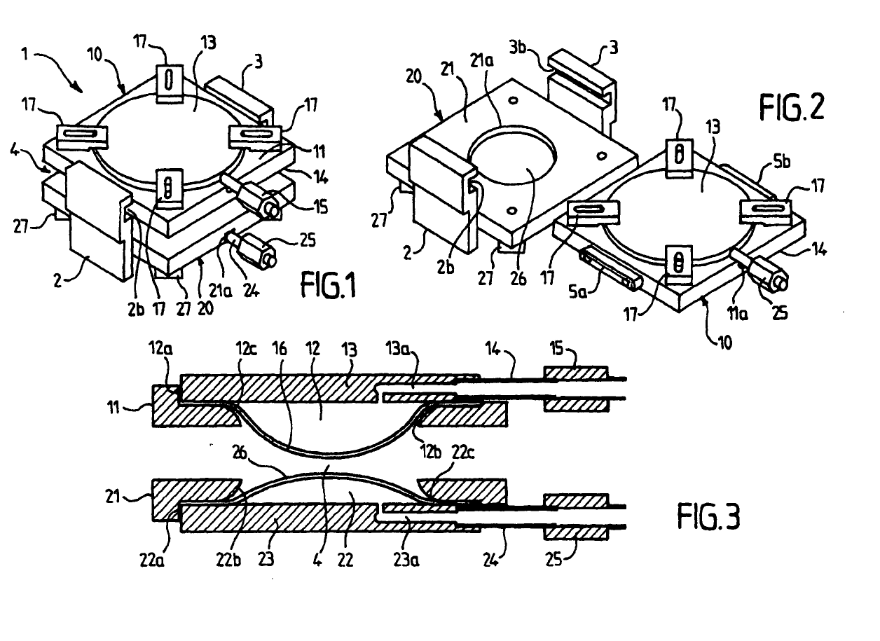

Referring to FIGS. 1 to 3, there is represented a dual inflatable membrane apparatus 1 which can be used for implementing the system and the process of the present invention.

As shown, the apparatus 1 comprises an upper inflatable membrane device 10 and a lower inflatable membrane device 20.

Both inflatable membrane devices 10, 20 are held together by means of two opposed flanges 2, 3 so that the upper inflatable membrane 16 of the upper device 10 faces the lower inflatable membrane 26 of the lower device 20 and the membranes 16, 26 define therebetween a receiving space 4.

Each of the lower and upper inflatable membrane devices 10, 20 comprises a body 11, 21, for example having a general parallelepipedic shape, provided each with a central through aperture 12, 22, each comprising a first part 12a, 22a, preferably of cylindrical shape, opening on one face of the body 11, 21 for accommodating a plug 13, 23 provided with a fluid admission passage 13a, 23a, for example a pressurized air admission passage, and a second part 12b, 22b in communication with the first part 12a, 22a and opening in the opposite face of the body 11, 21. The second parts 12b, 22b of the central apertures 12, 22 are preferably of trunconical shape with the interface 12c, 22c between the first parts 12a, 22a and the second parts 12b, 22b of the through apertures 12, 22 forming the greater base of the trunconical second parts 12b, 22b. Typically, the trunconical second parts 12b, 22b of the through apertures 12, 22 will have a height of from 10 to 50 mm, preferably 10 to 25 mm and a taper of 10 to 90°, preferably 30 to 50°.

The interfaces 12c, 22c between the first parts 12a, 22a and the second parts 12b, 22b of the through apertures 12, 22 are each obturated by an inflatable membrane 16, 26, which is pinched between plug 13, 23 and the body 11, 21, whereby the inflatable membranes 16, 26 are guided by the trunconical second parts 12b, 22b when inflated.

The plugs 13, 23 have a shape which allows a tight accommodation within the first parts 12a, 22a of the through apertures 12, 22, for example a complementary cylindrical shape. The plugs 13, 23 are maintained in place by a locking means such as latches 17, 27. These latches can be as represented four pivoting cleats.

Each plug 13, 23 comprises a fluid admission passage 13a, 23a having two open ends for introducing an inflation fluid such as pressurized air behind the inflatable membranes 16, 26. One end of the fluid admission passage 13a, 23a opens in one main face of the plugs 13, 23 and the other end opens in the lateral wall of the plugs 13, 23 and is connected to an admission tube 14, 24, which in turn can be connected to a control valve 15, 25. A groove 11a, 21a is provided in each body 11, 21 for accommodating admission tubes 14, 24.

The flanges 2, 3 are fixed, for example screwed, each on an opposite lateral wall of the body 21 of the lower inflatable membrane device 20 with upright portions thereof extending above the plane of the body 21 and comprising horizontal linear grooves 2b, 3b facing each other and intended to slidably received cooperating slides fixably mounted on opposite lateral walls of the body 11 of the upper inflatable membrane device 10.

The plugs 13, 23 and the inflatable membranes 16, 26 can be made, at least partly in a light transparent material, for example a UV transparent material, in order to allow light curing during the coating transfer, when necessary.

The inflatable membranes 16, 26 can be made of any elastomeric material which can be sufficiently deformed by pressurization with an appropriate fluid. Typically, the inflatable membranes have a thickness ranging from 0.50 mm to 5.0 mm and an elongation of 100 to 800%, and a durometer 10 to 100 shore A.

In operation, the upper inflatable membrane device 10 is mounted by slidably engaging the slides 5a, 5b into the grooves 2b, 3b so that inflatable membranes 16, 26 face each other. Then, the control valves 15, 25 can be connected through a line (not shown) to a pressurized air source and inflatable membranes 16, 26 can be controllably inflated.

By providing connectable/disconnectable means such as control valves 15, 25, the entire apparatus 1, with the optical article and the coated flexible carrier in place between the two inflated membranes 16, 26 may be easily transported, for example to a curing station such as an oven or a UV curing device, for completion of the transfer process, when necessary.

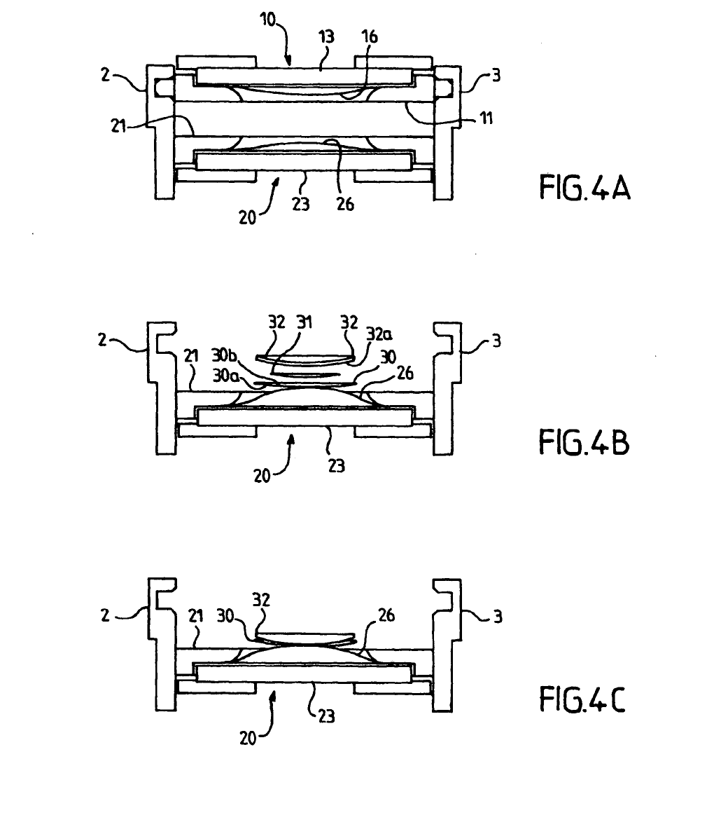

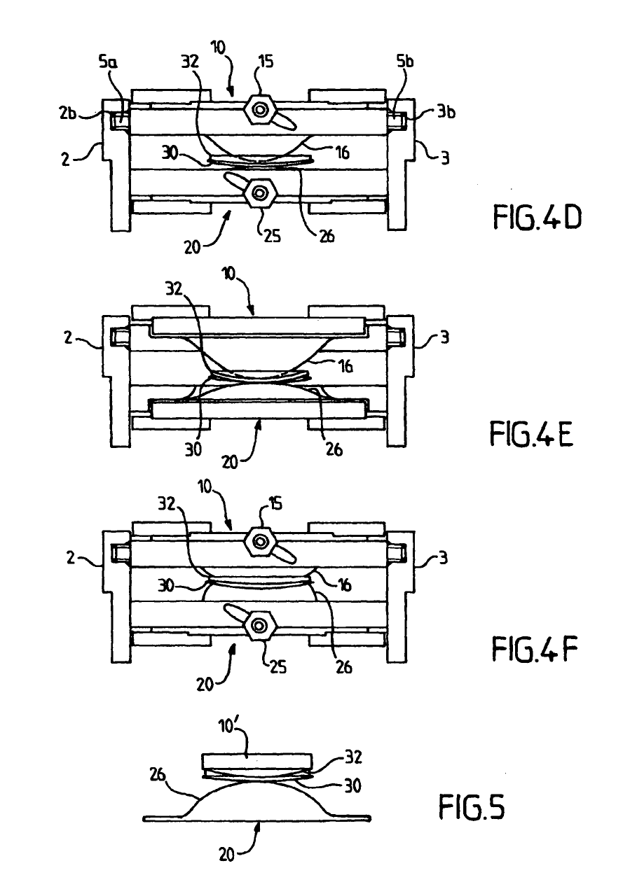

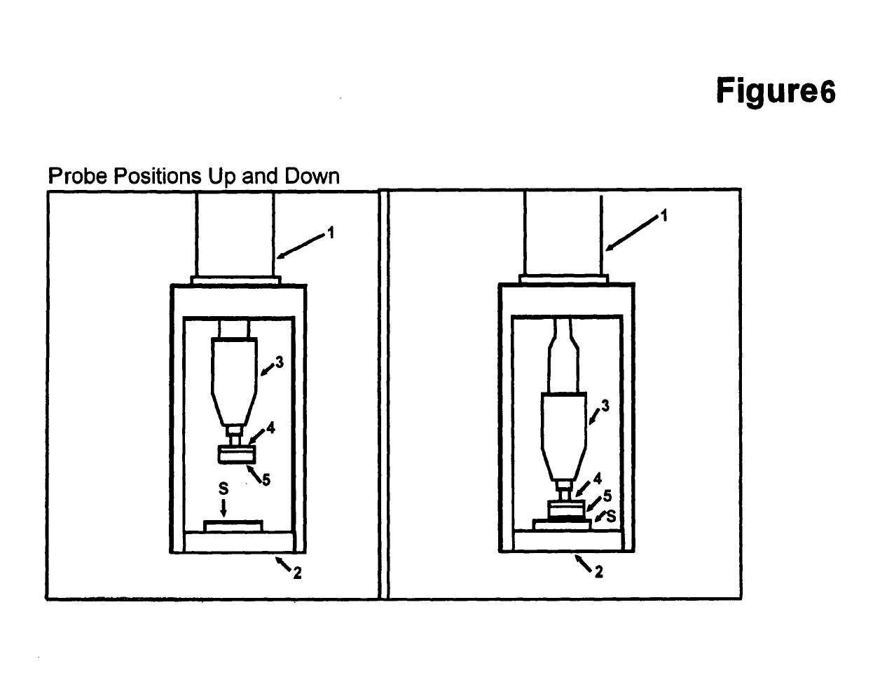

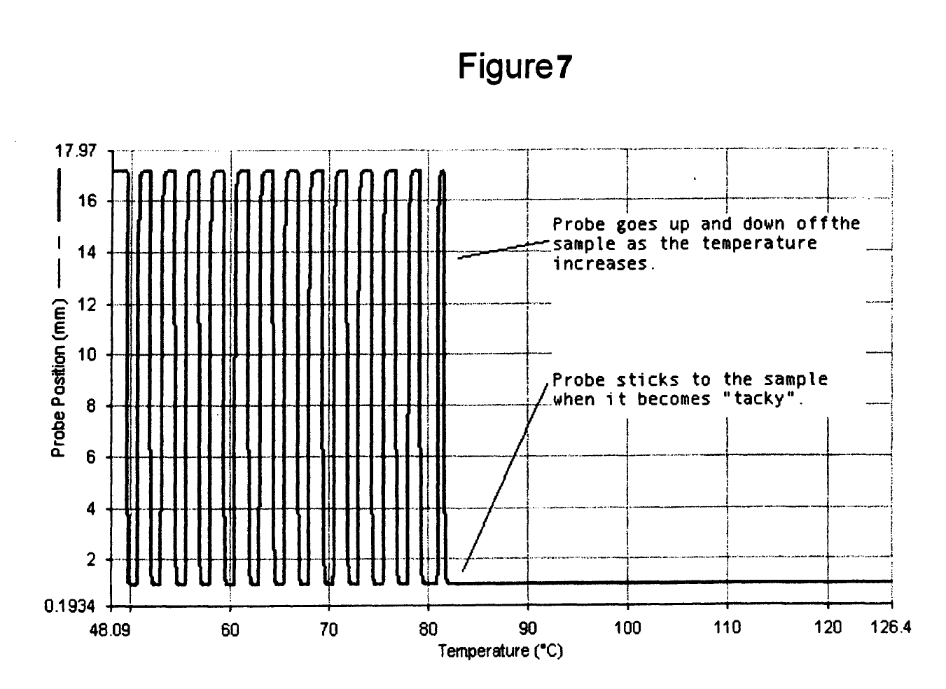

One embodiment of the process according to the invention, using the above dual inflatable membrane apparatus 1, will now be described in relation with FIGS. 4A to 4F.

FIG. 4A represents schematically the dual inflatable membrane apparatus 1 at the start of the process with both upper and lower inflatable membrane devices 10, 20 mounted in flanges 2, 3 and the respective inflatable membranes 16, 26 in a deflated state.

First, the upper inflatable membrane device 10 is removed form the flanges 2, 3 thanks to the sliding engagement and, as shown in FIG. 4B, a flexible carrier 30 having a convex surface 30a and a concave surface 30b, the concave surface 30b bearing a coating to be transferred, is placed on the inflatable membrane 26 with its convex surface 30a resting on the inflatable membrane 26 and its coated concave surface 30b facing upwardly.

Depending upon the nature of the outermost exposed layer of the coating born by the carrier 30, an amount of a liquid curable glue or of a water base activating liquid may or not be deposited on the coating (or on the optical article convex surface). Of course, if the outermost exposed layer of the coating exhibits adhesion properties, for example is a pressure sensitive adhesive (PSA), the deposition of a water base activating liquid is obviously not necessary.

Then, an optical article 32, for example an ophthalmic lens, having a front convex surface 32a and a back concave surface 32b is placed on the coated concave surface 30b of the flexible carrier with its front convex surface 32a resting thereon and its back concave surface 32a facing upwardly as shown in FIG. 4A.

The upper inflatable membrane device 10 is then mounted in flanges 2, 3 by sliding engagement of slides 5a, 5b in grooves 2b, 3b of the flanges 2, 3 and the control valves 15, 25 are connected to a pressurized fluid source such as a pressurized air source (not represented) (FIG. 4D). The upper membrane 16 is inflated until it touches the concave surface 32b of the optical article 32.

As shown in FIG. 4E, the pressure is then equalized in both upper and lower membranes 16, 26, and both membranes 16, 26 are inflated, preferably at the same speed, at preferably the same final pressure (FIG. 4F).

If necessary, the control valves 15, 25 may be closed and the apparatus 1 disconnected from the pressurized fluid source and the entire assembly, with the flexible carrier 30 and the optical article 32 pressed against each other by the inflatable membranes 16, 26 at their final pressure, may be transported to a curing device such as an oven or a UV curing device.

Thereafter, the control valves 15, 25 are opened and the membranes 16, 26 deflated. Upper inflatable membrane device 10 is removed from the flanges 2, 3 and the optical article 32 with its convex surface 32a coated with the coating is obtained.

The fluid pressure of the inflated membranes 16, 26 typically ranges from 30 kPa to 300 kPa, preferably 65 kPa to 150 kPa and is typically around 100 kPa.

The inflation is such that it takes about 10 to 60 seconds for increasing pressure from 0 to 15 psi.

The flexible carrier is generally a thin supporting element made of a plastic material, especially a thermoplastic material and in particular of polycarbonate. Typically, the flexible carrier has a thickness ranging from 0.2 to 5 mm, preferably from 0.5 to 2 mm.

The convex surface of the optical article 32 can be a naked surface, i.e. a surface free of any deposited coating layer, or it can be a surface already covered with one or more functional coating layers, especially a hard coating layer.

In particular, it can be a commercial hard coating, such as for example a PDQ hard coating.

Although the optical article 32 can be made of mineral glasses or organic glasses, it is preferably made of organic glass. The organic glasses can be either thermoplastic materials such as polycarbonates and thermoplastic polyurethanes or thermosetting (cross linked) materials such as diethyleneglycol bis(allylcarbonate)polymers and copolymers (in particular CR 39® ( from PPG Industries), thermosetting polyurethanes, polythiourethanes, polyepoxides, polyepisulfides, poly(meth)acrylates, polythio(meth)acrylates, as well as copolymers and blends thereof. Preferred materials for the optical article are polycarbonates and diethylene glycol bis(allyl carbonate)copolymers, in particular substrates made of polycarbonate.

The convex surface 32a of the optical article 32 to be coated is preferably pretreated. Any physical or chemical adhesion promoting pretreatment step can be used such as a solvent treatment. Preferably the convex surface 23a of the optical article to be coated is pretreated by corona discharge.

As already mentioned, the front convex surface base (B_{L}) of the optical article 32 and the concave surface base (B_{C}) of the flexible carrier 30 preferably satisfy the relationship:
B_{L}−B_{C}>0.25
More preferably, B_{L}−B_{C}>0.5
and even better 0.5<B_{L}−B_{C}<4
For a progressive ophthalmic lens having a progressive surface in the front side, one preferably fulfils the following relationship:
0.5<B′_{L}−B_{C}<8 wherein B′_{L} is defined as being B_{L}+ addition wherein B_{L} is the base of the progressive surface of the lens and addition is the additional power given by the progressive lens for near vision.

More preferably, 0.5<B′_{L}−B_{C}<6.

In this patent application, when one refers to the base curvature (or base) of the carrier, one means the base curvature of the working surface of the carrier, that is to say the surface which bears the coatings to be transferred to the optical article, after withdrawal of the carrier.

In the same way, base curvature (or base) of the optical article means the base curvature of the surface onto which the coating is to be transferred.

In this application, the base curvature has the following definition:

For a spheric surface, having a radius of curvature R, base curvature (or base)=530/R (R in mm).

Such a definition is quite classical in the art.

For a toric surface, there are two radii of curvature, and one calculates, according to the above formula, two base curvatures BR, Br with BR<Br.

The optical article is generally a lens or lens blank, preferably an ophthalmic lens or lens blank.

The optical article is preferably a lens blank.

Preferably, the main surface of the optical article onto which the coating is applied, is a geometrically defined surface, i.e. a surface which has been at least grinded to the required geometry.

The optical article may be polished or only fined without being polished.

The optical article may also be surfaced (grinded) and polished without being fined.

In particular, Surfacing machines using the technology CNC (Computer Numeric Control), for example from the Schneider company, allow to eliminate most of the defects (such as surface waves) due to the first grinding step and can prepare a surface having a state such as it is possible to avoid a fining step and directly implement the polishing step.

Using this technique, however, some surfacing individualized scratches may remain at the surface which has an arithmetic average roughness Ra typically varying from 0.001 to 0.01 micrometer.

The main surface of the optical article (preferably the front (convex) surface) on which the coating is to be transferred may be a spheric, aspheric or progressive surface.

When the transfer is made on both faces, the back face may be toric.

As said previously, a geometrically defined surface encompasseseither an optical surface, that is a surface of required geometry and smoothness or a surface having a required geometry but that may still exhibit some roughness, such as a lens blank that has been grinded and fined, but not polished to the required geometry. The surface roughness typically ranges from Sq 10⁻³ μm to 1 μm, preferably from 10₋₃ to 0.5 μm and most preferably from 10⁻³ to 0.1 μm.

Sq: Quadratic mean of the deviations from the mean

$$Sq = \sqrt{\frac{1}{NM} {\sum }_{x = 1}^{N} {\sum }_{y = 1}^{M} Z x , {y}^{2}}$$

Computes the efficient value for the amplitudes of the surfaces (RMS). This parameter is included in the EUR 15178 EN report (Commission of the European Communities) Stout et al.

1993: The development of methods for the characterization of roughness in three dimensions.

The roughness (S_{q}) was measured by P-10 long scan of KLA-tencor.

The measurement condition was under 2 μm tip 1 mg force 10 scans 500 μm long 2000 data points.

The state of the surface of a lens being fined without being polished can also be expressed in terms of Rq.

Preferably, such a lens substrate has a Rq which ranges from 0.01 micron to 1.5 microns, preferably from 0.05 to 1.5 microns; more preferably from 0.1 to 1 micron.

Rq is determined as follows:

A TAYLOR HOBSON FTS (Form Talysurf Series 2) profilometer/roughness measuring systems is advantageously used to determined the root-mean-square profile height Rq (2DRq) of the surface (also referred as roughness Rq before).

The system includes a laser head (product reference 112/2033-541, for example) and a 70 mm long feeler (product reference 112/1836) having a 2 mm radius spherical/conical head.

The system measures a two-dimensional profile in the chosen section plane to obtain a curve Z=f(x). In this example the profile is acquired over a distance of 20 mm.

Various surface characteristics can be extracted from this profile, in particular its shape, undulation and roughness.

Accordingly, to determine Rq, the profile is subject to two different processes, namely shape extraction and filtering, which corresponds to mean line extraction.

The various steps for determining a parameter Rq of this kind are as follows:
acquisition of the profile Z=f(x),
shape extraction,
filtering (mean line extraction), and
determination of parameter R_{q}.

The profile acquisition step consists in moving the stylus of the afore mentioned system over the surface of the lens in question, to store the altitudes Z of the surface as a function of the displacement x.

In the shape extraction step, the profile obtained in the previous step is related to an ideal sphere, i.e. a sphere with minimum profile differences relative to that sphere. The mode chosen here is the LS arc mode (best circular arc extraction).

This provides a curve representative of the characteristics of the profile of the surface in terms of undulation and roughness.

The filtering step retains only defects corresponding to certain wavelengths. In this example, the aim is to exclude undulations, a form of defect with wavelengths higher than the wavelengths of defects due to roughness. Here the filter is of the Gaussian type and the cut-off used is 0.25 mm.

Rq is determined from the curve obtained using the following equation:

$$Rq = \sqrt{\frac{1}{N} {\sum }_{n = 1}^{N} {( Zn )}^{2}}$$

Where Zn is, for each point, the algebraic difference Z relative to the mean line calculated during filtering.

The coating to be transferred may be a single coating or a stack of coating layers.

Usual functional coatings, as is well known, comprise hydrophobic/oleophobic top coats, anti-reflecting coatings, anti-abrasion and/or scratch-resistant coatings, impact-resistant coatings, polarized coatings, photochromic coatings, dyed coatings, optical-electronical coatings, electric-photochromic coatings, printed layers and wave front coating layers.

Preferably, the coating comprises a stack of coating layers including a hydrophobic top coat layer, an anti-reflective coating (AR coating) layer, a scratch and/or abrasion resistant coating (hardcoat) layer, and optionally an impact-resistant coating layer. These layers being deposited in this indicated order (reverse from the final order on the optical article) on the carrier concave surface.

The hydrophobic top coat, which in the finished optical article constitutes the outermost coating on the optical article, is intended for improving dirty mark resistance of the finished optical article and in particular of the anti-reflecting coating.

As known in the art, a hydrophobic top coat is a layer wherein the stationary contact angle to deionized water is at least 60°, preferably at least 750 and more preferably at least 90°, and even better more than 100°.

The stationary contact angle is determined according to the liquid drop method in which a water drop having a diameter smaller than 2 mm is formed on the optical article and the contact angle is measured.

The hydrophobic top coats preferably used in this invention are those which have a surface energy of less than 14 m Joules/m².

The invention has a particular interest when using hydrophobic top coats having a surface energy of less than 13 m Joules/m² and even better less than 12 m Joules/m².

The surface energy values referred just above are calculated according to Owens Wendt method described in the following document: “Estimation of the surface force energy of polymers” Owens D. K.-Wendt R. G. (1969) J. Appl. Polym. Sci., 1741-1747.

Such hydrophobic top coats are well known in the art and are usually made of fluorosilicones or fluorosilazanes i.e. silicones or silazanes bearing fluor-containing groups. Example of a preferred hydrophobic top coat material is the product commercialized by Shin Etsu under the name KP 801M.

Another preferred hydrophobic top coat is commercialized by Daikin under the trade name Optool DSX.

The top coat may be deposited onto the carrier using any typical deposition process, but preferably using thermal evaporation technique.

Thickness of the hydrophobic top coat usually ranges from 1 to 30 nm, preferably 1 to 15 nm.

Anti-reflecting coatings and their methods of making are well known in the art. The anti-reflecting coating can be any layer or stack of layers which improves the anti-reflective properties of the finished optical article.

The anti-reflecting coating may preferably consist of a mono- or multilayer film of dielectric materials such as SiO, SiO₂ Si₃N₄, TiO₂, ZrO₂, Al₂O₃, MgF₂or Ta₂O₅, or mixtures thereof.

The anti-reflecting coating can be applied in particular by vacuum deposition according to one of the following techniques:

1)—by evaporation, optionally ion beam-assisted;

2)—by spraying using an ion beam,

3)—by cathode sputtering; or

4)—by plasma-assisted vapor-phase chemical deposition.

In case where the film includes a single layer, its optical thickness must be equal to λ/4 where λ is wavelength of 450 to 650 nm.

Preferably, the anti-reflecting coating is a multilayer film comprising three or more dielectric material layers of alternatively high and low refractive indexes.

Of course, the dielectric layers of the multilayer anti-reflecting coating are deposited on the optical surface of the flexible carrier or the hydrophobic top coat in the reverse order they should be present on the finished optical article.

A preferred anti-reflecting coating may comprises a stack of four layers formed by vacuum deposition, for example a first SiO₂ layer having an optical thickness of about 100 to 160 nm, a second ZrO₂ layer having an optical thickness of about 120 to 190 nm, a third SiO₂ layer having an optical thickness of about 20 to 40 nm and a fourth ZrO₂ layer having an optical thickness of about 35 to 75 nm.

Preferably, after deposition of the four-layer anti-reflecting stack, a thin layer of SiO₂ of 1 to 50 nm thick (physical thickness) may be deposited. This layer promotes the adhesion between the anti-reflecting stack and the abrasion and/or scratch-resistant coating generally subsequently deposited, and is not optically active.

The next layer to be deposited is the abrasion and/or scratch-resistant coating. Any known optical abrasion and/or scratch-resistant coating composition can be used to form the abrasion and/or scratch-resistant coating. Thus, the abrasion and/or scratch-resistant coating composition can be a UV and/or a thermal curable composition.

By definition, an abrasion and/or scratch-resistant coating is a coating which improves the abrasion and/or scratch-resistant of the finished optical article as compared to a same optical article but without the abrasion and/or scratch-resistant coating.

Preferred abrasion and/or scratch-resistant coatings are those made by curing a precursor composition including epoxyalkoxysilanes or a hydrolyzate thereof, optionally colloidal mineral fillers and a curing catalyst. Examples of such compositions are disclosed in U.S. Pat. No. 4,211,823, WO 94/10230, U.S. Pat. No. 5,015,523, EP 614957.

The most preferred abrasion and/or scratch-resistant coating compositions are those comprising as the main constituents an epoxyalkoxysilane such as, for example, γ-glycidoxypropyltrimethoxysilane (GLYMO) and a dialkyldialkoxysilane such as, for example dimethyldiethoxysilane (DMDES), colloidal silica and a catalytic amount of a curing catalyst such as aluminum acetylacetonate or a hydrolyzate thereof, the remaining of the composition being essentially comprised of solvents typically used for formulating these compositions.

In order to improve the adhesion of the abrasion and/or scratch-resistant coating to the impact-resistant primer coating to be subsequently deposited or to the latex layer, an effective amount of at least one coupling agent can be added to the abrasion and/or scratch-resistant coating composition.

The preferred coupling agent is a pre-condensed solution of an epoxyalkoxysilane and an unsaturated alkoxysilane, preferably comprising a terminal ethylenic double bond.

Examples of epoxyalkoxysilanes are:

γ-(glycidoxypropyl)trimethoxysilane,

γ-(glycidoxypropyl)pentamethyldisiloxane,

γ-(glycidoxypropyl)methyldiisopropenoxysilane,

γ-(glycidoxypropyl)methyldiethoxy-silane,

γ-(glycidoxypropyl)dimethylethoxysilane,

γ-(glycidoxypropyl)diisopropylethoxysilane, and

γ-(glycidoxypropyl)bis(trimethylsiloxy)methylsilane.

The preferred epoxyalkoxysilane is γ-(glycidoxypropyl) trimethoxysilane.

The unsaturated alkoxysilane can be a vinylsilane, an allylsilane, an acrylic silane or a methacrylic silane.

Examples of vinylsilanes are vinyltris(2-methoxyethoxy)silane, vinyltrisisobutoxysilane, vinyltri-t-butoxysilane, vinyltriphenoxysilane, vinyltrimethoxysilane, vinyltriisopropoxysilane, vinyltriethoxysilane, vinyltriacetoxysilane, vinylmethyidiethoxysilane, vinyl methyidiacetoxy-silane, vinylbis(trimethylsiloxy)silane and vinyldimethoxyethoxysilane.

Examples of allylsilanes are allyltrimethoxysilane, alkyltriethoxysilane and allyltris(trimethylsiloxy)silane.

Examples of acrylic silanes are:

3-acryloxypropyltris(trimethylsiloxy)silane,

3-acryloxypropyltrimethoxysilane,

3-acryloxypropylmethyldimethoxysilane,

3-acryloxypropylmethylbis(trimethylsiloxy)silane,

3-acryloxypropyldimethylmethoxysilane,

n-(3-acryloxy-2-hydroxypropyl)-3-aminopropyltriethoxysilane.

Examples of methacrylic silanes are:

3-methacryloxypropyltris(vinyldimethoxylsiloxy)silane,

3-methacryloxypropyltris(trimethylsiloxy)silane,

3-methacryloxypropyltris(methoxyethoxy)silane,

3-methacrylo-xypropyltrimethoxysilane,

3-methacryloxypropylpentamethyl disiloxane,

3-methacryloxypropylmethyldimethoxysilane,

3-methacryloxypropylmethyldiethoxysilane,

3-methacryloxypropyldimethylmethoxysilane,

3-methacryloxypropyldimethylethoxysilane,

3-methacryloxypropenyltrime-thoxysilane,and

3-methacryloxypropylbis(trimethylsiloxy)methylsilane.

The preferred silane is acryloxypropyltrimethoxysilane.

Preferably, the amounts of epoxyalkoxysilane(s) and unsaturated alkoxysilane(s) used for the coupling agent preparation are such that the weight of epoxyalkoxysilane

$$R = \frac{weight of epoxyalkoxysilane}{weight of unsaturated alkoxysilane}$$

weight ratio
verifies the condition 0.8≦R≦1.2.

The coupling agent preferably comprises at least 50% by weight of solid material from the epoxyalkoxysilane(s) and unsaturated alkoxysilane(s) and more preferably at least 60% by weight.

The coupling agent preferably comprises less than 40% by weight of liquid water and/or organic solvent, more preferably less than 35% by weight.

The expression “weight of solid material from epoxyalkoxy silanes and unsaturated alkoxysilanes” means the theoretical dry extract from those silanes which is the calculated weight of unit Qₖ Si O_{(4-k)/2} where Q is the organic group that bears the epoxy or unsaturated group and Qₖ Si O_{(4-k)/2} comes from Qₖ Si R′O₍₄₋ₖ₎ where Si R′ reacts to form Si OH on hydrolysis.

k is an integer from 1 to 3 and is preferably equal to 1.

R′ is preferably an alkoxy group such as OCH₃.

The water and organic solvents referred to above come from those which have been,initially added in the coupling agent composition and the water and alcohol resulting from the hydrolysis and condensation of the alkoxysilanes present in the coupling agent composition.

Preferred preparation methods for the coupling agent comprises:

1) mixing the alkoxysilanes

2) hydrolysing the alkoxysilanes, preferably by addition of an acid, such a hydrochloric acid

3) stirring the mixture

4) optionally adding an organic solvent

5) adding one or several catalyst(s) such as aluminum acetylocetonate

6) Stirring (typical duration: overnight).

Typically the amount of coupling agent introduced in the scratch-resistant coating composition represents 0.1 to 15% by weight of the total composition weight, preferably 1 to 10% by weight.

The abrasion and/or scratch-resistant coating composition can be applied on the anti-reflecting coating using any classical method such as spin, dip or flow coating.

The abrasion and/or scratch-resistant coating composition can be simply dried or optionally precured before application of the subsequent impact-resistant primer coating (which may be the dry latex layer) or implementation of the process of the invention. Depending upon the nature of the abrasion and/or scratch-resistant coating composition thermal curing, UV-curing or a combination of both can be used.

Thickness of the abrasion and/or scratch-resistant coating, after curing, usually ranges from 1 to 15 μm, preferably from 2 to 6 μm.

Before applying the impact resistant primer on the scratch-resistant coating, it is possible to subject the surface of the scratch-resistant coating to a corona treatment or a vacuum plasma treatment, in order to increase adhesion.

The impact-resistant primer coating can be any coating typically used for improving impact resistance of a finished optical article. Also, this coating generally enhances adhesion of the scratch-resistant coating on the substrate of the finished optical article.

By definition, an impact-resistant primer coating is a coating which improves the impact resistance of the finished optical article as compared with the same optical article but without the impact-resistant primer coating.

Typical impact-resistance primer coatings are (meth)acrylic based coatings and polyurethane based coatings.

(Meth)acrylic based impact-resistant coatings are, among others, disclosed in U.S. Pat. No. 5,015,523, U.S. Pat. No. 6,503,631 whereas thermoplastic and cross linked based polyurethane resin coatings are disclosed inter alia, in Japanese Patents 63-141001 and 63-87223, EP-0404111 and U.S. Pat. No. 5,316,791.

In particular, the impact-resistant primer coating can be made from a latex composition such as a poly(meth)acrylic latex, a polyurethane latex or a polyester latex.

Among the preferred (meth)acrylic based impact-resistant primer coating compositions there can be cited polyethyleneglycol(meth)acrylate based compositions such as, for example, tetraethyleneglycoldiacrylate, polyethyleneglycol (200) diacrylate, polyethyleneglycol (400) diacrylate, polyethyleneglycol (600) di(meth)acrylate, as well as urethane(meth)acrylates and mixtures thereof.

Preferably the impact-resistant primer coating has a glass transition temperature (Tg) of less than 30° C.

Among the preferred impact-resistant primer coating compositions, there may be cited the acrylic latex commercialized under the name Acrylic latex A-639 commercialized by Zeneca and polyurethane latex commercialized under the names W-240 and W-234 by Baxenden.

In a preferred embodiment, the impact-resistant primer coating may also includes an effective amount of a coupling agent in order to promote adhesion of the primer coating to the optical substrate and/or to the scratch-resistant coating.

The same coupling agents, in the same amounts, as for the scratch-resistant coating compositions can be used with the impact-resistant coating compositions.

The impact-resistant primer coating composition can be applied on the scratch-resistant coating using any classical method such as spin, dip, or flow coating.

The impact-resistant primer coating composition can be simply dried or optionally precured.

The exposed layer of the coating in contact with the convex surface of the optical article may have adhesive properties or may be a latex coating having adhesive properties activable with water or a mixture of water and solvent. When the exposed layer has adhesive properties, there is no need to use a liquid curable glue or water or a mixture of water and solvent.

Example of materials for forming layers with adhesive properties are pressure-sensitive adhesives (PSA) and hot-melt adhesives (HMA).

By “pressure-sensitive adhesive” (or sometimes “self-adhesive material”), it is meant a distinct category of adhesives. PSAs are aggressively and permanently tacky in dry form (solvent-free) at room temperature or at temperature of use. They are characterized by their ability to firmly adhere to a variety of dissimilar surfaces under a slight pressure by forming Van der Waals bonds with said surfaces. In any case, no other external energy (such as temperature, solvent, UV . . . ) but pressure is compulsory to form the adhesive joint. However, other external energy may be used to enhance the adhesive performance. Another requirement is that PSAs should have a sufficient cohesive strength to be removed by peeling without leaving residues to said surfaces. PSAs are available into three forms: solvent born, water born (latex) and the form obtained by hot melt process. The dry and unflowable PSA layers according to the invention may be formed by evenly applying a liquid form or by transferring a dry layer previously formed on a functional coating. Thereafter, if liquid, the deposited layer is dried to an unflowable state by heating. Usually, heating will be performed at a temperature ranging from 40° C. to 130° C.

By “hot-melt adhesive”, it is intended to mean a room temperature solid but flexible adhesive, which melts or drops in viscosity upon heating, and rapidly sets with cooling to create a bond. Preferably, the HMA used in the present invention will not be flowable even after heating because it is laminated firstly in very tight conditions. So the variation of thickness of the adhesive layer in the final lens, when coatings are transferred, will typically be less than 2 microns.

HMAs can be repeatedly softened by heat and hardened or set by cooling (thermoplastic HMAs), except for reactive HMAs, which are applied like conventional HMAs but cross-link forming permanent, non-remelting bonds. Additives such as siloxanes or water can be used to form the cross-linked bonds. An important property of HMAs is the ability to solidify or congeal or “set” very rapidly under normal ambient conditions, preferably almost instantaneously, when cooling down from the application temperature. They are available in dry form, or in solvent and latex based forms. The dry and unflowable layers according to the invention may be formed by evenly applying a liquid form on either a geometrically defined surface of the lens substrate or a functional coating. Thereafter, the deposited liquid latex layer is dried to an unflowable state by heating. Usually, heating will be performed at a temperature ranging from 40° C. to 130° C. When a dry form is used, it is heated to the temperature where it will flow readily, and then it is applied to either a geometrically defined surface of the lens substrate or a functional coating. It can also be extruded into place by using a hot-melt extruder or die face.

As is known in the art, if a polymer or polymer blend does not have the properties of a PSA or a HMA per se within the meaning of these terms as used herein, it can function as a PSA or a HMA by admixture with small quantities of additives. In some embodiments, the transparent adhesive composition of the invention may comprise, apart from the polymer material, tackifiers, preferably tackifier resins, plasticizers, diluents, waxes, liquid oils and various other components for adjusting the tack, rheology characteristics (including viscosity, thixotropy, and the like), adhesive bond strength characteristics, rate of “set”, low temperature flexibility, color, odor, etc. Such plasticizers or tackifying agents are preferably compatible with the blend of polymers, and include: aliphatic hydrocarbons, mixed aliphatic and aromatic hydrocarbons, aromatic hydrocarbons, hydrogenated esters and polyterpenes.

In a preferred embodiment, the transparent adhesive composition may also include an effective amount of a coupling agent (as defined hereinafter) in order to promote its adhesion with the geometrically defined surface of the lens substrate and/or the functional coating to be transferred, in particular an abrasion and/or scratch-resistant coating layer. The transparent adhesive composition may also comprise a classical dye or a photochromic dye.

The families of PSAs are classified according to the main elastomer used in the adhesive formulation. The main families are: natural rubber based PSAs, polyacrylates based PSAs (such as polyethylhexyl acrylate, poly n-butyl acrylate), styrenic block copolymers based PSAs [such as Styrene-Isoprene (SI), Styrene-Isoprene-Styrene (SIS), Styrene-Butadiene (SB), Styrene-Butadiene-Styrene (SBS)], and mixtures thereof. Styrene-butadiene random copolymers, butyl rubber, polyisobutylene, silicon polymers, synthetic polyisoprene, polyurethanes, polyvinyl ethyl ethers, polyvinyl pyrrolidone, and mixtures thereof, may also be used as bases for PSA formulations. For examples, see Sobieski et al., Handbook of Pressure-Sensitive Adhesive Technology, 2nd ed., pp. 508-517 (D. Satas, ed.), Van Nostrand Reinhold, New York (1989), incorporated by reference in its entirety.

The PSAs used in this invention are preferably selected from polyacrylate based PSAs and styrenic block copolymers based PSAs.

Examples of polymers, which can be used for formulating HMAs are solvent-free polyamides, polyethylene, polypropylene and other olefin-type polymers, polyurethanes, polyvinyl pyrrolidones, polyesters, poly(meth)acrylic systems, other copolymers thereof, and mixtures thereof. The hot-melt adhesives according to the invention are preferably selected from dry poly(meth)acrylic latexes, such as the acrylic latex commercialized under the name Acrylic latex A-639 by Zeneca, dry polyurethane latexes, such as the latexes commercialized under the names W-240 and W-234 by Baxenden, dry polyester latexes and mixtures thereof. Preferred latexes are polyurethane latexes. Other preferred latexes are core/shell latexes such as those described in U.S. Pat. No. 6,503,631 to Essilor and especially latexes based on alkyl(meth)acrylates such as butyl acrylate or butyl methacrylate.

Application of the liquid activable latexes can be performed by any usual process such a dip coating, flow coating or spin coating. Thereafter, the deposited liquid latex layer is dried by heating. Usually, heating will be performed at a temperature ranging from 40° C. to 130° C. and will be preferably pursued until at least a tack free layer is obtained. Typically heating will last from 60° to 100° C. for 15 seconds to 90 seconds.

Preferred latexes are (meth)acrylic latexes such as the acrylic latex commercialized under the name Acrylic latex A-639 by Zeneca, polyurethane latexes such as the latexes commercialized under the names W-240 and W-234 by Baxenden and polyester latexes. Preferred latexes are polyurethane latexes.

Other preferred latexes are core/shell latexes such as those described in Essilor U.S. Pat. No. 6,503,631 and especially latexes based on alkyl(meth)acrylates such as butylacrylate or butyl(meth)acrylate.

In a preferred embodiment, the latex layer may also include an effective amount of a coupling agent (as previously defined) in order to promote adhesion of the latex layer with the substrate and/or the coating, in particular an abrasion and/or scratch-resistant coating.

The latexes may also comprise a classical dye or a photochromic dye.

Latexes comprising a photochromic dye and the method for obtaining them are disclosed for example in the following Essilor patents: EP 161512; U.S. Pat. No. 6,770,710; U.S. Pat. No. 6,740,699.

Polyphasic photochromic latexes, especially those having a core/shell structure wherein the photochromic dye is incorporated in the core are preferred.

Generally, after drying and curing the latex layer has a thickness ranging from 0.05 to 30 μm, preferably from 0.5 to 20 μm and better from 0.6 to 15 μm.

The latex layer may preferably constitute an impact-resistant primer coating of the coated optical article.

Then the latex preferably fulfills the preferred requirements of impact resistant primer coating such as Tg of the latex layer being less than 30° C.

Dry latex layers with low glass transition temperature are preferred since they result in a better transfer and a better adhesion. Thus, the dry latex preferably has a Tg lower than 0° C., more preferably lower than −10° C., better lower than −2° C. and even better lower than −40° C.

Also, dry latexes having low “tacky” temperatures are preferred. Thus, preferred dry latexes have “tacky” temperatures ≦80° C., generally ranging from 40° C. to 80° C., preferably from 50° C. to 75° C.

Determination of the “tacky” temperature of the dry latex layer.

Basically, the test for measuring the “tacky” temperature consists in repeatedly moving down a probe so that a flat end of the probe touches the latex layer under a specified pressure (positive force) and lifting off the probe from the latex layer under a specified force (negative force) while the layer is subjected to a programmed temperature increase. The “tacky” temperature is the temperature at which the probe sticks to the layer and is no longer able to be lifted off from the sample.

The “tacky” temperature is measured using a Perking Elmer Dynamic Mechanical Analyser, schematically represented in FIG. 4, working in creep-recovery mode. A creep-recovery test is a test in which a constant load is applied for a specified duration of time on the sample and dimensional distortion is monitored. Then the load is released (but still having enough force to stay in contact with the sample) and the recovering ability of the material is monitored. However, in the measurement of the “tacky” temperature the Perkin Elmer DMA is used in a somewhat unconventional way in the “creep-recovery mode”.

More specifically, the latex composition is spin coated on a flat polycarbonate sheet and dried at 85° C. for 15 minutes. Small rectangular samples (1.5 cm×0.5 cm) are cut from the PC sheet. For each kind of dry latex layers two samples are tested. If repeatable temperature is not obtained with two samples, more samples are tested until repeatable data is obtained. Typically the dried latex layer, for this test, has a thickness of 4 to 7 μm.

Referring to FIG. 4, the sample S is secured on the supporting plate 2 of the analyzer 1, with the latex layer facing the probe 3, using a double sided adhesive tape.

A generic differential scanning calorimetry pan 5 (typically 6.7 mm conventional aluminum DSC pan) is placed over the flat tip 4 of the probe.

The probe is moved down into contact with the latex layer and lifted off the layer under specified conditions while the temperature of the DSC pan is increased according to a program until the probe sticks to the layer. Movement of the probe during temperature increase is registered as shown in FIG. 5. The “tacky” temperature is the temperature at which the probe sticks to the layer.

The following parameters have been used for measuring the “tacky” temperature.

Perkin Elmer DMA 7e Analyzer-Creep Recovery mode Creep: 30 mN (positive force. Probe down), 0.5 minute;

Recovery: −25 mN (Negative force. Probe up), 0.5 minute;

Parallel Plates diameters.
Top probe plate 5 mm/with DSC pan 6.7 mm
Bottom plate (support) 20 mm

Heat program: 50-100° C. at 2.5° C./minute

Nitrogen Purge/Intracooler 1

“Tacky” temperatures for some dry latex layers are given in Table below.

| | Thickness of latex | “Tacky” temperature |
|---|---|---|
| Latex layer | layer (μm) | (° C.) |
| Witcobond W 213 | 3.9-4.0 | 90-93 |
| Witcobond W 234 with | 4.9-5.2 | 61 |
| coupling agent | | |
| Witcobond W 240 | 4.45 | 112-117 |
| Witcobond W 234 | 6.2-7.3 | 49-54 |
| without coupling agent | | |

With such dry latex layers as the means capable to allow adhesion, there is preferably used water or a mixture of water and organic solvent as an adhesion activating agent.

Water is preferably dionized water, or a mixture of water and one or more classical organic solvents such as alkanols, typically C₁-C₆ alkanols, for example methanol or ethanol. Preferably there is no organic solvent.

Typically there is deposited at least one drop of activating aqueous liquid, preferably at the center of the dry latex coating born by the concave surface of the carrier.

The liquid curable glue or adhesive may be any curable glue or adhesive, preferentially a thermally curable or photocurable, in particular UV curable, glue or adhesive that will promote adhesion of the coating to the surface of the optical article without impairing the optical properties of the optical article.

Some additives such as photochromic dyes and/or pigments may be included in the glue.

Although the liquid glue or adhesive is preferably dispersed at the center, it can be dispersed in a random pattern, spread out firstly via spin coating, or sprayed using a precision dispensing valve. By even layer distribution, it is meant that the variation of thickness of the glue or adhesive layer, once cured, has no consequence on the optical power of the final optical article.

The curable glue or adhesive can be polyurethane compounds, epoxy compounds, (meth)acrylate compounds such as polyethyleneglycol di(meth)acrylate, ethoxylated bisphenol A di(meth)acrylates.

The preferred compounds for the curable glue or adhesive are acrylate compounds such as polyethyleneglycoldiacrylates, ethoxylated bisphenol A diacrylates, various trifunctional acrylates such as (ethoxylated) trimethylolpropane triacrylate and tris(2-hydroxyethyl)isocyanurate.

Monofunctional acrylates such as isobornylacrylate, benzylacrylate, phenylthioethylacrylate are also suitable.

The above compounds can be used alone or in combination.

Preferably, when cured, the glue layer has an even thickness.

The thickness of the final glue layer after curing is less than 100 μm, preferably less than 80 μm, most preferably less than 50 μm and usually 1 to 30 μm.

In a preferred embodiment the coating is a stack of coating layers comprising, starting from the concave surface of the flexible carrier, a hydrophobic and/or oleophobic top coat, an anti-reflecting coating, an abrasion and/or scratch-resistant coating and an impact primer coating (HMC). Preferably, the impact primer coating is a dry latex layer whose adhesive properties can be activated by means of water or a mixture of water and at least one organic solvent.

The dry latex primer coating may be photochromic, preferably polyphasic latex layer. Such photochromic latexes are disclosed in U.S. Pat. No. 6,770,710.

In a more preferred embodiment, the coating is a stack of coating layers comprising a photochromic latex layer and deposited above this photochromic layer a polyurethane latex layer which can act as an adhesive when put into contact with water or water/solvent and heated.

Also, in a preferred embodiment, the front convex surface of the optical article is coated with a coating comprising principally a hydrolysate of γ-glycidoxypropyltrimethoxysilane (GLYMO), colloidal silicon, a catalyst such as an aluminum chelate (aluminum acetylacetonate) and an organic solvent such as an alkanol, for example methanol. Preferably, the optical article coating is submitted to a corona treatment prior to the implementation of the transfer process.

FIG. 5 is a schematic view of a pressing apparatus according to the invention in which the upper inflatable device 10 has been replaced by a rubber cushion 10′. Otherwise, the system and the process are the same as described above.

The rubber material can be any rubber material having the required resiliency and preferably is a silicone foam rubber. Typically, the rubber has a Shore A (measured according to Shore A (DIN 53505) for soft rubber) ranging from 10 to 70, an Elongation ranging from 200 to 900% and a tensile Strength ranging from 3500 to 7500 kPa. It preferably has a firmness rating of 4 to 12.

Preferably, the rubber cushion is a disk having a diameter close to the diameter of the lens to be coated, typically 70 mm, and a thickness preferably ranging from 8 to 20 mm, typically 13 mm.

One suitable material is a super-resilient high temperature silicone foam rubber. This material is a closed-cell foam rubber which maintains its resiliency even after extended compression.

It has a Shore A of 50, a tensile strength of 6200 kPa, and an elongation of 450%.

The following examples illustrate the present invention.

General Considerations

In all examples there was used a 0.5 mm polycarbonate (PC) carrier of various base curves bearing on its concave surface a coating stack including, starting from the carrier, a top coat, an anti-reflection coating, an abrasion and/or scratch resistant coating and a latex adhesive layer as the last exposed layer. Such a coating stack is called HMC coating.

STEP 1: Deposition of Protecting and Releasing Coating

The composition of the protecting and releasing coating was as follows:

| Component | Parts by weight |
|---|---|
| PETA LQ (acrylic ester of pentaerythritol) | 5.00 |
| Dowanol PnP | 5.00 |
| Dowanol PM | 5.00 |
| n-propanol | 5.00 |
| 1360 (Silicone Hexa-acrylate, Radcure) | 0.10 |
| Coat-O-Sil 3503 (reactive flow additive) | 0.06 |
| Photoinitiator | 0.20 |

The PC carrier is cleaned using soapy water and dried with compressed air. The carrier concave surface is then coated with the above protecting coating composition via spin coating with application speed of 600 rpm for 3 seconds and dry speed of 1200 rpm for 6 seconds. The coating is cured using Fusion System H+ bulb at a rate of 1.524 m/minute (5 feet per minute).

STEP 2: Deposition of Hydrophobic Top Coat and Anti-Reflective (AR) Coating

The PC carrier after deposition of the protecting coating is vacuum coated as follows:

A/Standard Vacuum AR Treatment: The Vacuum AR treatment is accomplished in a standard box coater using well known vacuum evaporation practices. The following is one procedure for obtaining the VAR on the mold:

1. The carrier having the protective coating already applied on the concave surface is loaded into a standard box coater and the chamber is pumped to a high vacuum level.

2. Hydrophobic coating (Chemical=Shin Etsu KP801M) is deposited onto the surface of the carrier using a thermal evaporation technique, to a thickness in the range of 2-15 nm.

3. The dielectric multilayer AR coating, consisting of a stack of sublayers of high and low refractive index materials is then deposited, in reverse of the normal order. Details of this deposition are as such:

The optical thicknesses of the alternating low and high refractive index layers are presented in the table (They are deposited in the indicated order, from the mold surface):

| | | |
|---|---|---|
| Low index | 103-162 | nm |
| High index | 124-190 | nm |
| Low index | 19-37 | nm |
| High index | 37-74 | nm |

A preferred stack is a stack wherein the low index material is SiO₂ and the high index material is ZrO₂.

B/At the completion of the deposition of the four-layer anti-reflection stack, a thin layer of SiO₂, comprising of a physical thickness of 1-50 nm, is deposited. This layer is to promote adhesion between the oxide anti-reflection stack and a lacquer hard-coating which will be deposited on the coated mold at a later time.

STEP 3: Deposition of Hard Coat (HC)

The composition of the hard coating is as follows:

| Component | Parts by weight |
|---|---|
| Glymo | 21.42 |
| 0.1N HCl | 4.89 |
| Colloidal silica | 30.50 |
| Methanol | 29.90 |
| Diacetone alcohol | 3.24 |
| Aluminum acetylacetonate | 0.45 |
| Coupling agent | 9.00 |
| Surfactant FC-430 (3M company) | 0.60 |

The PC carrier after deposition of protecting coating and AR coating in Steps 1 and 2 is then spin coated by HC solution at 600 rpm/1200 rpm, and precured 10 minutes at 80° C.

STEP 4: Deposition of Latex Primer Coating

Two different latex primer compositions are used.
latex primer coating No 1.

The composition of the primer is as follows:

| Component | Parts by weight |
|---|---|
| Polyurethane latex W-234 | 35.0 |
| Deionized water | 50.0 |
| 2-Butoxy ethanol | 15.0 |
| Coupling agent | 5.00 |

The PC carrier (with protective coating, AR coating and Hard coating) is spin coated at 600 rpm/1200 rpm with the latex primer solution and postcured for 1 hour at 80° C.

The obtained primer layer has a thickness of 1.96 micrometers.

This primer layer will be used as an adhesive layer in the following examples.
latex primer coating No. 2

This latex is a photochromic latex of the core/shell type with the core being polymethylmethacrylate with a dimethacrylate crosslinking agent and shell being butylmethacrylate.

The latex is prepared according to the general process described in U.S. Pat. No. 6,770,710 with 6% by weight of photochromic compound 3H-naphto[2,1-b]pyran, 3-(2,4-dimethoxyphenyl)-3-(4-methoxyphenyl)-(9Cl).

The PC carrier (with protective coating, AR coating and Hard coating) is spin coated with the photochromic latex solution at 200 rpm for 5 seconds, then 600 rpm for 5 seconds and 1000 rpm for 1 second. The latex layer is then heated at 110° C. for 20 minutes.

The obtained photochromic layer thickness is 9 micrometers.

Then a polyurethane latex primer layer (based on W 234 from Baxenden) is formed using the same composition and same process as for latex primer coating No1.

HMC coating with top coat/AR/hard coat and latex coating No1 is called HMC 1 and HMC coating with top coat/AR/hard coat/latex coating No2 and latex coating No1 applied over it is called HMC 2.

The coupling agent is a precondensed solution of:

| Component | Parts by weight |
|---|---|
| GLYMO | 10 |
| (Glycidoxypropyltrimethoxysilane) | |
| Acryloxypropyltriméthoxysilane | 10 |
| 0.1 N HCl | 0.5 |
| Aluminum acetylacetonate | 0.5 |
| Diacetone alcohol | 1.0 |

Lens Preparation:

Polycarbonate lenses, of various front convex surface base curves, are treated for coating the convex surface. The coating composition comprises essentially a hydrolyzate of γ-glycidoxypropyltrimethoxysilane, colloidal silica, aluminum acetyl acetonate(catalyst) and an organic solvent.

The hard coating is then corona discharge treated using 3DT equipment. The lens goes in front of the discharge head at a speed of 17 mm/s. There is 4 passes with a 5 s delay between each pass. Then, the lens is lowered down in order to treat its upper part and goes through another set of 4 passes with 5 s delays in between at a speed of 17 mm/s.

Corona power is applied under 15 000 to 20 000 volts.

### EXAMPLE 1

The concave surface of a 1.5 base PC carrier is coated with HMC 1. This carrier is placed in a dual membrane pressing apparatus as described above with its concave surface facing upwardly. A few drops of deionised water are deposited on the concave surface of the carrier and then a PC lens (power −2.00 dioptries) with a front convex surface base of 3.25 is placed on the concave surface of the carrier with its front convex surface facing the carrier. Thereafter the two inflatable membranes are pressurized up to 105 kPa to deform the flexible carrier so that it matches the front convex surface of the lens. The all assembly, with the inflatable membranes under pressure, is placed in an oven and heated at 110° C. for 45 minutes. After, the heating cycle, the dual inflatable membrane apparatus is opened, the carrier is removed, and a lens having its front convex surface coated with the HMC 1 coating is recovered. The HMC 1 coating transferred very well to the lens. There is no anti-reflection coating cracking during the transfer although the carrier base is much lower than the lens front convex surface base.

### EXAMPLES 2 TO 4

Example 1 is repeated using lenses of different front convex surface bases and carriers of different concave surface bases. Transfer is as good as in example 1. Parameters and results are shown in Table I.

### EXAMPLES 5 TO 6

Example 1 is repeated except that the HMC coating used is HMC 2.

HMC 2 is transferred on the front curvex surface of the lens. The photochromic property of the obtained lens is confirmed in the sunlight and a very uniform photochromic color change of the lens is obtained. There is no AR cracking or photochromic damages during this transfer.

Parameters and results are shown in Table 1.

TABLE I
FST(Front Side Transfer)-film transfer

| | Lens | Corona | | | | Carrier | Double | | |
|---|---|---|---|---|---|---|---|---|---|
| | front | treating | | Front | | base − Lens | membrane | | |
| | side | on lens | Carrier | curve | Carrier | front | pressure | Heating | HMC layer |
| Example | coating | front side | coating | base | base | base | (PSI) | conditions | transfer |
| Ex. 1 | Yes | Yes | HMC1 | 3.25 | 1.5 | 1.75 | 15.00 | 45 min/110 c | Good |
| Ex. 2 | Yes | Yes | HMC1 | 4.25 | 1.5 | 2.75 | 15.00 | 45 min/110 c | Good |
| Ex. 3 | Yes | Yes | HMC1 | 4.25 | 3.0 | 1.25 | 15.00 | 45 min/110 c | Good |
| Ex. 4 | Yes | Yes | HMC1 | 5.50 | 3.0 | 2.5 | 15.00 | 45 min/110 c | Good |
| Ex. 5 | Yes | Yes | HMC2 | 4.25 | 3.0 | 1.25 | 15.00 | 45 min/110 c | Good |
| Ex. 6 | Yes | Yes | HMC2 | 5.5 | 3.0 | 2.5 | 15.00 | 45 min/110 c | Good |

### EXAMPLE 7

Example 5 is reproduced except that the lens is a progressive lens base of negative power −1.75 dioptries, a base of 4.25 with a progressive addition in the front side of the lens of +2.5.

### EXAMPLES 8 TO 9

Example 1 is repeated with −2.00 and −3.00 dioptries sphere polycarbonate lenses with front convex curve base of 3.10˜3.12 and center thickness of 1.50 and 1.57 mm. The front transfer process (FST) is the same as in Ex. 1. The front curve base before and after FST is checked by Sag gauge (20 mm diameter) made by Mitutoyo Co. The obtained lens has no any optical deformation seen by the eye.

### COMPARATIVE EXAMPLES C1 AND C2

Examples 8 and 9 are repeated, except that the lower inflatable membrane device is replaced by a resilient silicon foam cushion having a Shore A of 50, a tensile strength of 6200 kPa, and an elongation of 450%. The FST process is the same as in Examples 8 and 9. The obtained lens has some optical distortion seen by naked eye from the reflection light because the front convex surface base is changed or bent during the FST process cycle as shown in Table II.

### EXAMPLES 10 AND 11

Examples 8 and 9 are repeated, except the upper inflatable membrane device is replaced by a resilient silicon foam cushion which is a disk having a diameter of 70 mm, and a thickness of 13 mm (see FIG. 5) having a shore A of 50, a tensile strength of 6200 kPa, and an elongation of 450%. The obtained lens has negligible optical distortion seen by naked eye from the reflection light as shown in Table 3.

TABLE II
FST(Front Side Transfer) - film transfer (continued)

| | | | | | Front | | |
|---|---|---|---|---|---|---|---|
| | Lens | Center | Front base | | base | Lens optical | HMC |
| | power | thickness | before | FST thermal | after | deformation | layer |
| Ex | (dioptries) | (mm) | FST | cycle | FST | after FST | transfer |
| 8 | −2.00 | 1.50 | 3.12 | 110° C./45 min | 3.10 | No | good |
| 9 | −3.00 | 1.57 | 3.10 | 110° C./45 min | 3.0 | No | good |
| C1 | −2.00 | 1.50 | 3.12 | 110° C./45 min | 2.35 | Strong | |
| C2 | −3.00 | 1.58 | 3.10 | 110° C./45 min | 2.50 | Strong | |
| 10 | −2.00 | 1.50 | 3.10 | 110° C./45 min | 3.02 | negligible | good |
| 11 | −3.00 | 1.58 | 3.10 | 110° C./45 min | 2.75 | Lightly | good |

*Lens optical deformation was checked by human eye from the reflection light of a lens

1.-38. (canceled)

39. A system for transferring at least one coating from a carrier on a front convex surface of an optical article comprising:
an optical article comprising a front convex surface and a back concave surface;
a flexible carrier comprising a concave surface and a convex surface, said concave surface of the carrier bearing at least one coating to be transferred and facing the front convex surface of the optical article;
an inflatable membrane positioned in front of the convex surface of the flexible carrier; and
a deformable part positioned in front of the back concave surface of the optical article and able to match the geometry of the back concave surface of the optical article when a pressure is exerted on the optical article through inflation of the inflatable membrane.

40. The system of claim 39, further comprising an exposed adhesive layer formed on the coating or the front convex surface of the optical article.

41. The system of claim 39, further comprising a dry latex layer which becomes adhesive when activated by a water base activating liquid formed on the coating or the front convex surface of the optical article.

42. The system of claim 39, further comprising a liquid curable glue deposited on the coating or the front convex surface of the optical article.

43. The system of claim 39, wherein the deformable part is a rubber cushion.

44. The system of claim 43, wherein the rubber cushion is made of a silicone foam rubber.

45. The system of claim 39, wherein the deformable part is an additional inflatable membrane which is itself inflated under pressure during use.

46. The system of claim 39, wherein the difference between the optical article front convex surface base (BL) and the carrier base (BC) concave surface is higher than 0.25.

47. The system of claim 46, wherein the difference between the optical article front convex surface base (BL) and the carrier base (BC) concave surface is higher than 0.5.

48. The system of claim 39, wherein the optical article front convex surface base and the carrier base concave surface satisfy the relationship: 0.5<BL−BC<4.

49. The system of claim 39, wherein said at least one coating is an adhesion promoting primer coating, an anti-abrasion and/or scratch-resistant coating, an impact-resistant coating, an anti-reflecting coating, a hydrophobic top coat, a polarized coating, a photochromic coating, a dyed coating, an optical-electronical coating, an electric-photochromic coating, or a printed layer.

50. The system of claim 39, wherein said at least one coating is a stack of coatings comprising, starting from the concave surface of the flexible carrier, a hydrophobic top coat, an anti-reflective coating, an abrasion and/or scratch-resistant coating.

51. The system of claim 50, wherein an adhesion promoting/impact-resistant coating is provided either on the abrasion and/or scratch resistant coating or on the convex surface of the optical article.

52. The system of claim 51, wherein the adhesion promoting/impact-resistant coating is a polyphasic photochromic latex layer.

53. A process for making a coated optical article comprising:
providing an optical article having a front convex surface and a back concave surface;
providing a flexible carrier having a concave surface and a convex surface, said concave surface of the carrier bearing at least one coating;
providing an apparatus comprising a deformable part and an inflatable membrane device, the deformable part and the inflatable membrane of the inflatable membrane device defining there between a receiving space;
positioning the carrier on the inflatable membrane, within the receiving space;
placing the optical article in front of the flexible carrier, with its convex surface facing the flexible carrier and its concave surface facing the deformable part;
inflating the membrane of the inflatable membrane device, so that the coated concave surface of the carrier matches the convex surface of the optical article;
deflating the membrane of the inflatable membrane device; and
recovering the optical article with its front convex surface coated with said at least one coating transferred from the flexible carrier.

54. The process of claim 53, further comprising placing the optical article on the concave surface of the flexible carrier with its convex surface facing the flexible carrier and its concave surface facing the deformable part.

55. The process of claim 53, further comprising providing an exposed adhesive layer formed on the coating or the front convex surface of the optical article.

56. The process of claim 53, further comprising providing a dry latex layer which becomes adhesive when activated by a water base activating liquid formed on the coating or the front convex surface of the optical article and further comprising the step of depositing an amount of a water base activating liquid either on the dry latex layer, the coating borne by the flexible carrier or the front convex surface of the optical article.

57. The process of claim 53, further comprising providing a liquid curable glue deposited on the coating or the front convex surface of the optical article, and further comprising curing the glue capable to allow adhesion.

58. The process of claim 53, wherein the deformable part is an additional inflatable membrane of an additional inflatable membrane device, the previous inflatable membrane device constituting a first inflatable membrane device and the additional inflatable membrane device constituting a second inflatable membrane device, both inflatable membranes being inflated at the same time.

59. The process of claim 58, wherein the inflatable membrane of both first and second inflatable membrane devices are inflated at the same speed.

60. The process of claim 58, wherein the inflatable membrane of the first inflatable membrane device is inflated first until it touches the center of the concave surface of optical article, then pressure is equalized in both membranes and finally both membranes are simultaneously inflated at the same speed.

61. The process of claim 53, wherein no coating is transferred on the back surface of the optical article.

62. The process of claim 58, further comprising:
providing an additional flexible carrier having concave and convex surfaces, the convex surface thereof bearing at least one coating to be transferred; and
before inflating the membranes, placing the additional flexible carrier on the concave surface of the optical element with the concave surface of the flexible carrier facing the inflatable membrane of the second inflatable membrane device;
whereby both surfaces of the optical article are coated simultaneously.

63. The process of claim 62, further comprising providing an exposed adhesive layer formed on the coating or the back concave surface of the optical article.

64. The process of claim 62, further comprising providing a dry latex layer which becomes adhesive when activated by a water base activating liquid formed on the coating or the back concave surface of the optical article and further comprising the step of depositing an amount of a water base activating liquid either on the dry latex layer, the coating borne by the flexible carrier or the back concave surface of the optical article.

65. The process of claim 62, further comprising providing a liquid curable glue deposited either on the coating or the back concave surface of the optical article.

66. The process of claim 53, wherein the front convex surface base of the optical element (BL) and the concave surface base of the carrier (BC) satisfy the relationship: BL−BC>0.25.

67. The process of claim 66, wherein the front convex surface base of the optical element (BL) and the concave surface base of the carrier (BC) satisfy the relationship: BL−BC>0.5.

68. The process of claim 66, wherein the front convex surface base of the element (BL) and the concave surface base of the carrier (BC) satisfy the relationship: 0.5<BL−BC<4.

69. The process of claim 53, wherein said at least one coating is an adhesion promoting primer coating, an anti-abrasion and/or scratch-resistant coating, an impact-resistant coating, an anti-reflecting coating, a hydrophobic top coat, a polarized coating, a photochromic coating, a dyed coating, an optical-electronical coating, an electric-photochromic coating; a printed layer or a wave front coating layer.

70. The process of claim 53, wherein said at least one coating is a stack of coatings comprising, starting from the concave surface of the flexible carrier, a hydrophobic top coat, an anti-reflective coating, an abrasion and/or scratch-resistant coating, and optionally an impact resistant coating.

71. The process of claim 70, wherein said at least one coating further comprises an impact resistant coating.

72. The process of claim 53, wherein the latex comprises a poly(meth)acrylic latex, polyurethane latex, and/or polyester latex.

73. The process of claim 72, wherein the organic solvent is an alkanol.

74. The process of claim 53, wherein the optical article is made of a thermoplastic or thermosetting organic material.

75. The process of claim 74, wherein the optical article comprises a polycarbonate, a thermoplastic or thermosetting polyurethane, a polythiourethane, a polyepoxide, a polyepisulfide, a poly(meth)acrylate, a polythio(meth)acrylate, and/or a diethyleneglycol bisallylcarbonate copolymer.

76. The process of claim 53, wherein the carrier is made of a thermoplastic material.

77. The process of claim 76, wherein the thermoplastic material is a polycarbonate.

78. The process of claim 76, wherein the flexible carrier has a thickness of 0.2 to 5 mm.

79. A coated flexible carrier having a concave surface and a convex surface, the concave surface of the carrier being coated, starting from the surface of the carrier, with a hydrophobic and/or oleophobic top coat, an anti-reflecting coating, an abrasion and/or scratch resistant coating and a dry photochromic latex coating.

80. The flexible carrier of claim 79, wherein the dry photochromic latex later is a polyphasic photochromic latex layer.

81. The flexible carrier of claim 79, wherein the carrier is made of polycarbonate.
